(19) United States
(12) Patent Application Publication
(10) Pub. No.: US 2003/0119512 A1
(43) Pub. Date: Jun. 26, 2003

(54) Base station control equipment load distributed system

(75) Inventor: Hiroaki Nakashima, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/327,016

(22) Filed: Dec. 24, 2002

(30) Foreign Application Priority Data
Dec. 26, 2001 (JP) 2001-395111

(51) Int. Cl. H04Q 7/20; H04M 1/00; H04B 1/38

(52) U.S. Cl. 455/439; 455/560

(57) ABSTRACT

In the cellular mobile communication system comprising an MSC (Mobile-services Switching Center), a plurality of kinds of BSC (Base Station Control equipment), and a plurality of BTSes (Base Transceiver Station), the MSC was configured to comprise load status supervision/control means for supervising and controlling a load status of the BSC, each kind of the BSC to comprise data management means for managing a base station number etc. of the BTS to be managed as a subordinate of its own BSC, and call process ability management means for managing call process ability of its own BSC and the BTS under command thereof, and each BTS to comprise base station control equipment storage means for storing the BSC to which its own BTS should make access.

### BACKGROUND OF THE INVENTION

The present invention relates to a base station control equipment load distributed system, and more particular to a base station control equipment load distributed system that, in a cellular mobile communication system, in the event that the situation occurred that base station control equipment, which managed a plurality of base transceiver stations, had to perform a call process beyond its own call process ability, by switching the above call process over to the other base station control equipment of which load is light, enables execution of a load distribution of the base station control equipment.

As a rule, the cellular mobile communication system is configured of: a base transceiver station (hereinafter, referred to as BTS for short) for facing a mobile station (hereinafter, referred to as MS for short) via radio to carries out a resource management etc. of a radio circuit; base station control equipment (hereinafter, referred to as BCS for short) for taking a radio control etc. for a plurality of BTSes; and a mobile-services switching center (hereinafter, referred to as MSC for short) for exercising control over a plurality of kinds of the BSC, and taking an exchange control of a call etc., and the MSC, which is further connected to the other MSC and the other communication network etc., is adapted to take a connection control of the call between the MS and the other MS or a fixed terminal.

And, normally, one kind of the BSC is adapted to control a plurality of the BTSes, and a communication network configuration between the BSC and the BTC, as shown in FIG. 9A, FIG. 9B and FIG. 9C, is adapted to take any configuration of a star connection that the BTSes are connected to the BSC in a star shape (FIG. 9A), a cascade connection that the BTSes are connected to the BSC in a cascade shape (FIG. 9B), and a loop connection that the BTSes and the BSC are connected via a loop network (FIG. 9C). Also, the BTSes that one kind of the BSC controls are decided in a fixed manner, in an example shown in FIG. 9, one kind of BSC 120-1 is adapted to control three BTSes 140-1, 140-2 and 140-3, the BTSes 140-1, 140-2 and 140-3 are constantly under command of the BSC 120-1, and there is no possibility that they are positioned under control of the other BSC, for example, the BSC 120-2.

In the conventional cellular mobile communication system mentioned above, an arrangement of the BTSes and the BSC is decided so that quality of communication in the MS does not deviate from a specification value, and yet the configuration is made so that an operation status of each BTS is supervised or controlled from the BSC and the MSC that is ranked more highly than it; however the BTS under command of the BSC is in a fixed status, whereby it has the problem that, in the event that the MSes concentrated under command of a certain BTS, and the traffic became excessive, there is the case that the communication quality deviates from a specification value, and the defect that, in the event that a certain kind of the BSC failed, the BTS under command of the above BSC falls into a status that the operation is impossible.

### SUMMARY OF THE INVENTION

The present invention has been accomplished so as to improve the foregoing circumstances, and an objective thereof is to provide the base station control equipment load distributed system that, in the cellular mobile communication system, comprises a function capable of retrieving the base station control equipment (BSC) on which the call processes concentrate, and enables execution of a load distribution so that load of the call process does not concentrate on a specific kind of the base station control equipment (BSC).

The first present invention is, in a cellular mobile communication system comprising; an MSC (Mobile-services Switching Center); a plurality of kinds of BSC (Base Station Control equipment) to be connected to said MSC via a first communication network; and a plurality of BTSes (Base Transceiver Station) to be connected to said plurality of kinds of said BSC via a second communication network, said second communication network being a loop network, a base station control equipment load distributed system that is characterized in that: said MSC comprises load status supervision/control means for supervising and controlling a load status of said plurality of kinds of said BSC; each of said plurality of kinds of said BSC comprises data management means for managing a base station number etc. of the BTS to be managed as a subordinate of its own BSC, and call process ability management means for managing call process ability of its own BSC and the BTS under command thereof, respectively; each of said plurality of said BTSes comprises base station control equipment storage means for storing the BSC to which its own BTS should make access, respectively; and in the event that load of a call process of any kind of the BSC becomes heavy and the process of a call became impossible to perform in the above BSC, said load status supervision/control means of said MSC switches over so as to select the other kind of the BSC, of which load is light, for causing it to perform the process of the above call.

The second present invention is the base station control equipment load distributed system in the first present invention that is characterized in that said load status supervision/control means of said MSC is configured of: a traffic measurement section for measuring a traffic amount of each kind of said BSC and each of said BTSes; a call process ability registration table for establishing the BSC of which a call process ability threshold was not exceeded; a green base station table for, in the event that the call process ability of any kind of the BSC was exceeded and the call process became impossible to start, registering the BTS under command of the above BSC; and a base station control equipment processing section for performing a supervision/control process of each kind of said BSC by referring to said call process ability registration table and said green base station table.

The third present invention is the base station control equipment load distributed system in the second present invention that is characterized in that: said data management means of said BSC is configured of a base station data base for establishing the base station number of the BTS that its own BSC manages, and a base station data processing section for carrying out registration/deletion of the base station number to/from said base station data base, and registration etc. of its own BSC for said base station control equipment storage means of the BTS that its own BSC manages; and said call process ability management means is configured of a call process correspondence section for performing the call process for said BTS, a call process ability threshold comparison section for making a comparison of the current call process ability of its own BSC and the BTS under command thereof with a pre-established call process ability threshold, and a traffic data acquisition section for acquiring and housing traffic data that said MSC measured in said traffic measurement section.

The fourth present invention is the base station control equipment load distributed system in the third present invention that is characterized in that: said base station control equipment storage means of said BTS is configured of a standard base station control equipment storage section in which the BSC, to which its own BTS is normally connected, was registered, and a base station control equipment call process access table in which the BSC, which its own BTS asks for the process of a current call, is registered; and said BTS further comprises a traffic upper-limit storage section in which an upper-limit value of the call process ability of its own BTS is established.

The fifth present invention is the base station control equipment load distributed system that is characterized in that: in an initial stage of a system start of the cellular mobile communication system in the fourth present invention, when said BTS transmits an ATM packet to the BSC of an access destination registered in said base station control equipment call process access table for making access, a pre-set process operation of said BSC is started (step S200); said base station data base is retrieved by said base station data processing section of said BSC to confirm whether said BTS of an access source is under command of its own BSC (step S201); next, by said traffic data acquisition section, a traffic upper-limit value of said BTS and a traffic measurement value are acquired from said traffic upper-limit storage section of said BTS and said traffic measurement section of said MSC respectively, said traffic measurement value being a current traffic of said BTS (step S202); by determining whether said traffic measurement value did not exceed said traffic upper-limit value, it is determined whether the call process ability of said BTS was not exceeded (step S203); in the event that said traffic measurement value did not exceed said traffic upper-limit value, it is determined that said current traffic measurement value did not exceed a call process ability threshold of the above BTS (No in the step S203), the base station number of the above BTS is re-established in said base station data base (step S204) to finish the process (the operation proceeds to step S207); in the event that said traffic measurement value exceeded the traffic upper-limit value in the step S203, it is determined that said current traffic measurement value exceeded the call process ability threshold of the above BTS (Yes in the step S203), and the base station number of the above BTS is deleted from said base station data base (step S205); and the base station number of the above BTS is sent to said base station control equipment processing section of said MSC from said base station data processing section, and is registered in said green base station table (step S206) to finish the process (step S207).

The sixth present invention is the base station control equipment load distributed system that is characterized in that: when the pre-set process operation in the fifth present invention is finished in all kinds of said BSCs, said MSC retrieves whether the BTS is registered in said green base station table; if the BTS was registered, said base station control equipment processing section of said MSC retrieves and assigns the BSC, of which the threshold of the call process ability was not exceeded, from said call process ability registration table, and registers the BTS registered in said green base station table to said base station data base of the above BSC, and said BTS registered in said base station data base of the above BSC is deleted from said green base station table; and the BSC, of which said base station data base of its own had said BTS registered newly by said MSC, establishes its own BSC in said base station control equipment call process access table of the above BTS by said base station data processing section.

The seventh present invention is the base station control equipment load distributed system that is characterized in that: when the operation described in the sixth present invention is finished, and the cellular mobile communication system is placed in operation, a dynamic process operation is started at each call of the MS (Mobile Station); in said dynamic process operation, it is determined at each call whether the call process ability threshold pre-established in said BSC was exceeded; in the event that the call process ability threshold of said BSC was not exceeded, the process of the above call is performed in the above BSC; and in the event that the call process ability threshold of said BSC was exceeded, the BSC is switched over so as to cause the other BSC having a call process ability margin to perform the process of the above call for executing a load distribution of the BSC.

The eighth present invention is the base station control equipment load distributed system that is characterized in that: when the operation described in the seventh present invention was finished, and the cellular mobile communication system is placed in operation, at the time that a call occurred in the MS (Mobile Station), the above call reaches said call process correspondence section of the BSC via said radio control section and said communication circuit control section of the BTS, and the dynamic process operation of said BSC is started (step S300); said BSC initiates execution of the process of the above call (step S301); next, said BSC determines, when its own BSC performs the process of the above call, whether or not the call process ability threshold pre-established in its own BSC is exceeded (step S302); in the step S302, in the event that it was determined in said call process ability threshold comparison section that, even though its own BSC performed the process of the above call, the call process ability threshold of its own BSC would not be exceeded (No in the step S302), the process of the above call is performed by its own BSC (step S308) to finish the process (the operation proceeds to step S309); in the step S302, in the event that it was determined in said call process ability threshold comparison section that, if its own BSC performed the process of the above call in the step S302, the call process ability threshold of its own BSC would be exceeded (Yes in the step S302), said BSC makes a report of the threshold being exceeded to said base station control equipment processing section of said MSC from said base station data processing section (step S303); said base station control equipment processing section of said MSC, which received a report of the threshold being exceeded, retrieves said call process ability registration table, and selects and decides the other BSC of which the call process ability threshold was not exceeded, and said base station control equipment processing section makes access to said base station data processing section of said other BSC that was newly-selected (step S304), and registers and establishes the base station number of said BTS that is going to process the above call into said base station data base of said other BSC (step S305); said other BSC, which was newly selected, makes access to said BTS from said base station data processing section, and establishes its own BSC (said other BSC) in said base station control equipment call process access table of said BTS (step S306); said BTS, of which said base station control equipment call process access table had said other BSC established, asks said other BSC, which was established, for a connection process of the above call, and said other BSC performs the process of the above call (step S307) to finish the process (step S309).

The ninth present invention is the base station control equipment load distributed system that is characterized in that: when the operation described in the eighth present invention was finished, and a clearing notice reaches said BSC from said BTS (step S400), a clearing retrieval process in said BSC is started (step S401); it is determined whether said BSC also made clearing (step S402), if said BSC did not make clearing (No in the step S402), the process is finished (the operation proceeds to step S406), and if said BSC made clearing in the step S402 (Yes in the step S402), it is determined whether a call process amount of said BSC became smaller than the call process ability threshold of said BSC (step S403); in the step S403, if a call process amount of said BSC did not become smaller than the call process ability threshold (No in the step S403), the BSC established in said base station control equipment call process access table of said BTS is left as it stands (step S404) to finish the process (step S406); and in the step S403, if a call process amount of said BSC became smaller than the call process ability threshold (Yes in the step S403), the BSC established in said base station control equipment call process access table of said BTS is restored to its original status (step S405) to finish the process (step S406).

The tenth present invention is, in a cellular mobile communication system comprising an MSC (Mobile-services Switching Center), a plurality of kinds of BSC (Base Station Control equipment) to be connected to said MSC via a first communication network, and a plurality of BTSes (Base Transceiver Station) to be connected to said plurality of kinds of said BSC in a cascade shape via a third communication network, a base station control equipment load distributed system that is characterized in that: said MSC comprises load status supervision/control means for supervising and controlling a load status of said plurality of kinds of said BSC; each of said plurality of kinds of said BSC comprises data management means for managing a base station number etc. of the BTS to be managed as a subordinate of its own BSC, and call process ability management means for managing call process ability of its own BSC and the BTS under command thereof, respectively; each of said plurality of said BTSes comprises base station control equipment storage means for storing the BSC to which its own BTS should make access, respectively; and in the event that load of the call process of any kind of the BSC became heavy and the process of a call became impossible to perform in the above BSC, said load status supervision/control means of said MSC switches over so as to select the other kind of the BSC, of which load is light, for causing it to perform the process of the above call.

### BRIEF DESCRIPTION OF THE DRAWINGS

This and other objects, features and advantages of the present invention will become more apparent upon a reading of the following detailed description and drawings, in which:

FIG. 1 is a block diagram illustrating one embodiment of the base station control equipment load distributed system of the present invention;

FIG. 2 is a detailed block diagram illustrating one example of the base station control equipment load distributed system of this embodiment;

FIG. 3 is a flow chart explaining the pre-set process operation of this embodiment;

FIG. 4 is a flow chart explaining the dynamic process operation of this embodiment;

FIG. 5 is a view illustrating one example of a relation between a call amount and time;

FIG. 6 is a view schematically explaining the dynamic process operation of this embodiment;

FIG. 7 is a flow chart explaining the clearing process operation of this embodiment;

FIG. 8 is a block diagram illustrating the second embodiment of the base station control equipment load distributed system of the present invention;

FIG. 9A is a view illustrating the conventional communication network configuration between the BSC and the BTSes;

FIG. 9B is a view illustrating the conventional communication network configuration between the BSC and the BTSes and

FIG. 9C is a view illustrating the conventional communication network configuration between the BSC and the BTSes.

### DESCRIPTION OF THE EMBODIMENTS

Next, embodiments of the present invention will be explained by referring to the accompanied drawings.

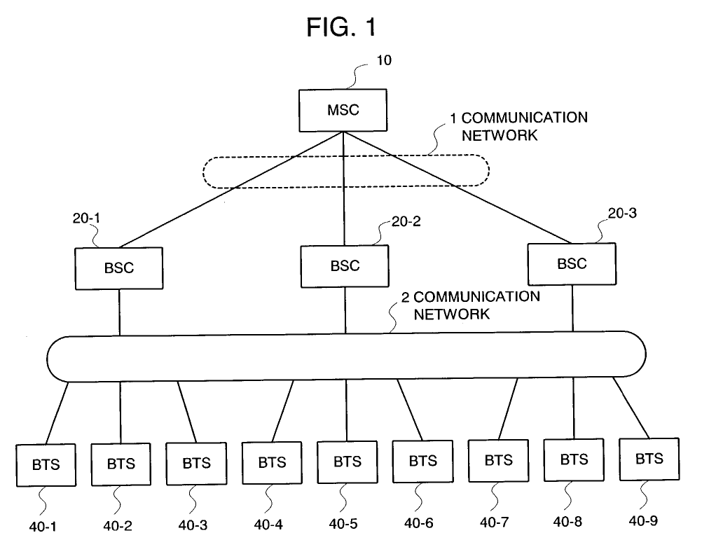

FIG. 1 is a block diagram illustrating one embodiment of the base station control equipment load distributed system of the present invention.

This embodiment shown in FIG. 1 is configured of an MSC (Mobile-services Switching Center) 10, a plurality of kinds of the BSC (Base Station Control equipment) 20 (20-1, 20-2 and 20-3), and a plurality of BTSes (Base Transceiver Station) 40 (40-1 to 40-9), the MSC 10 and each kind of the BSC 20 are connected via a communication network 1, and further each kind of the BSC 20 is connected to a plurality of the BTSes 40 via a communication network 2 that is a loop network.

The MSC 10 comprises a load status supervision/control function for each kind of the BSC 20 in addition to a normal function for taking an exchange control of the call and exercising control over the BSC 20. Additionally, the MSC 10 may be a switching center that is further connected to the other mobile-services switching center (MSC) and the other communication network that are not shown in the figure.

Each kind of the BSC 20 comprises a data management function for the BTS 40 to be managed as a subordinate of its own BSC 20, and a call process ability management function for its own BSC 20 and the BTS 40 under command thereof in addition to a normal function such as a radio control for a plurality of the BTSes 40.

Each kind of the BTS 40 comprises a base station control equipment storage function for storing the BSC 20, to which its own BTS 40 should make access, in addition to a normal function such as a resource management of a radio circuit between itself and the MS (mobile station).

Additionally, the communication network 1 for connecting the MSC 10 and the BSC 20, and the communication network 2 for connecting the BSC 20 and the BTS 40 should be a network in which supervision/control information can be communicated as an ATM (Asynchronous Transfer Mode) packet in addition to normal call process communication.

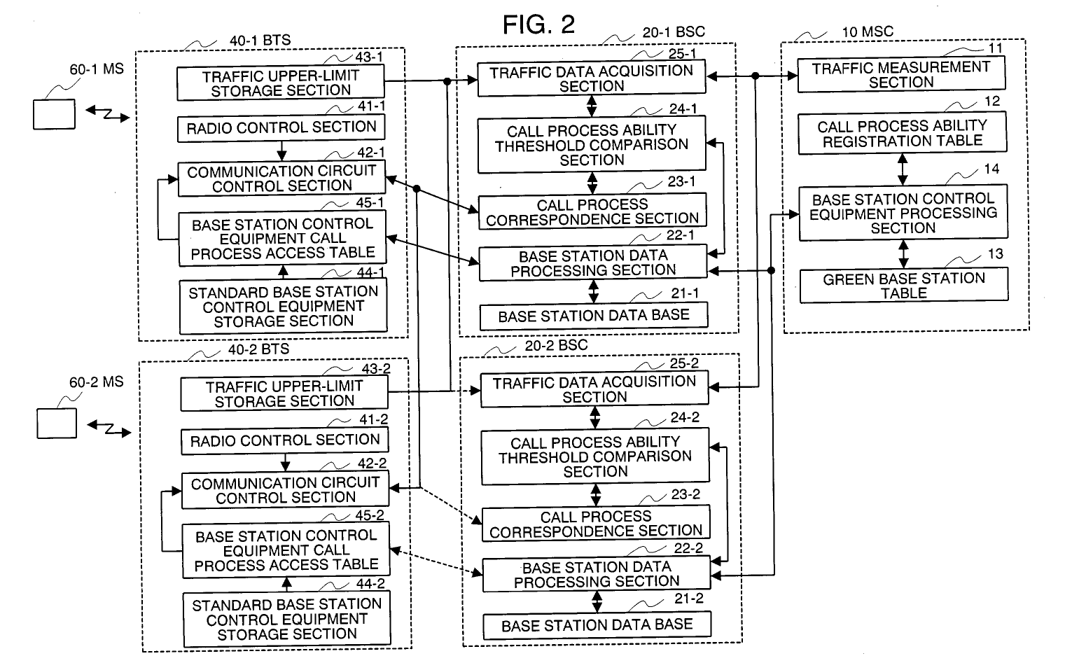

Next, a detailed configuration of this embodiment will be explained by referring to FIG. 2.

FIG. 2 is a detailed block diagram illustrating one example of the base station control equipment load distributed system of this embodiment. Additionally, in FIG. 2, identical reference numerals or codes are affixed to components that correspond to ones shown in FIG. 1, explanation thereof is omitted, and also, illustration of the communication network 1 and the communication network 2 shown in FIG. 1 is omitted in FIG. 2.

In FIG. 2, in addition to a normal function for taking an exchange control of the call and exercising control over the BSC 20 (illustration is omitted), as a load status supervision/control function, the MSC 10 comprises: a traffic measurement section 11 for measuring a traffic amount of each kind of the BSC 20 and each BTS 40; a call process ability registration table 12 for establishing the BSC 20 of which the call process ability threshold was not exceeded; a green base station table 13 for, in the event that the call process became impossible to start because the call process ability of any kind of the BSC 20 was exceeded, registering the BTS 40 under command of the above BSC 20; and a base station control equipment processing section 14 for, by referring to the call process ability registration table 12 and the green base station table 13, performing a supervision/control process of the BSC 20.

Since each kind of the BSC 20 has the same configuration entirely, only the BSC 20-1 and the BSC 20-2 are illustrated, the BSC 20-3 is not illustrated, and the BSC 20-1 will be explained as a representative.

In addition to a normal function (illustration is omitted) such as a radio control for a plurality of the BTSes 40, as a data management function for the BTS 40 to be managed as a subordinate of the BSC 20-1, the BSC 20-1 comprises: a base station data base 21 (base station data base 21-1) for establishing the base station number of the BTS 40 that the BSC 20-1 manages; and a base station data processing section 22 (base station data processing section 22-1) for carrying out registration/deletion of the base station number to/from the base station data base 21-1, and registration etc. of itself, i.e. the BSC 20-1 for a base station control equipment storage function of the BTS 40 that the BSC 20-1 manages.

Also, as a call process ability management function for its own BSC 20-1 and the BTS 40 under command thereof, it comprises: a call process correspondence section 23 (a call process correspondence section 23-1) for performing the call process for the BTS 40; a call process ability threshold comparison section 24 (call process ability threshold comparison section 24-1) for comparing the current call process ability of its own BSC 20-1 and the BTS 40 under command thereof with a pre-established call process ability threshold; and a traffic data acquisition section 25 (traffic data acquisition section 25-1) for acquiring and housing traffic data that the MSC 10 measured in the traffic measurement section 11.

Since each BTS 40 has the same configuration entirely, only the BTS 40-1 and the BTS 40-2 are illustrated, the BTS 40-3 to the BTS 40-9 are not illustrated, and the BTS 40-1 will be explained as a representative.

The BTS 40-1 comprises: as a normal function such as a resource management of a radio circuit between itself and the MS (Mobile Station) 60 (MS 60-1), a radio control section 41 (radio control section 41-1) for taking control of the call process, i.e. the communication process, a communication circuit control section 42 (communication circuit control section 42-1) for controlling a communication circuit between itself and the BSC 20, and a traffic upper-limit storage section 43 (traffic upper-limit storage section 43-1) in which the upper-limit value of the call process ability of its own BTS 40-1 was established; and as a base station control equipment storage function, a standard base station control equipment storage section 44 (standard base station control equipment storage section 44-1) in which the BSC 20, to which the BTS 40-1 is normally connected, was registered, and a base station control equipment call process access table 45 (base station control equipment call process access table 45-1) in which the BSC 20 that the BTS 40-1 asks for the process of the current call is registered,.

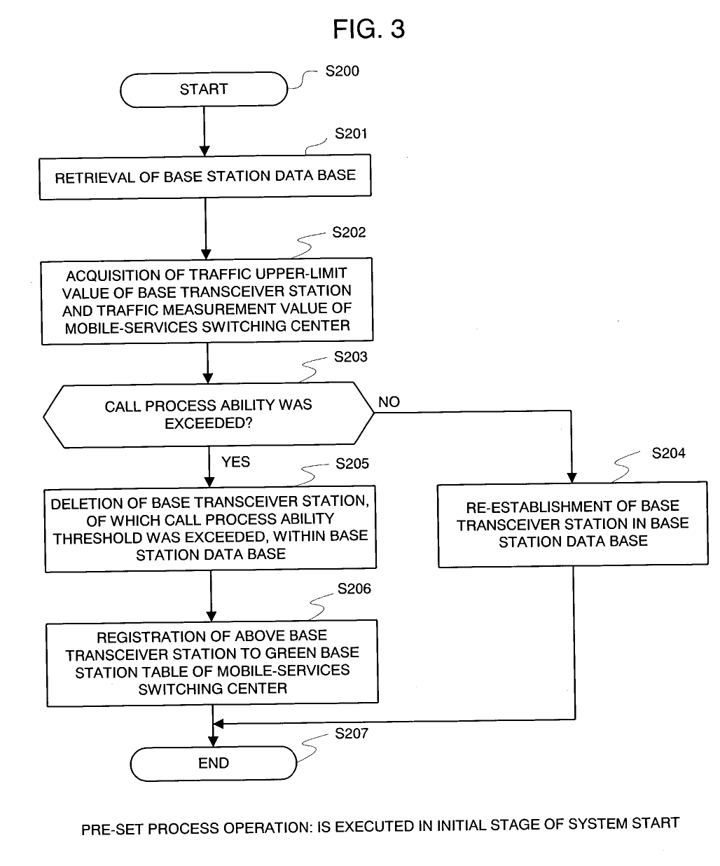

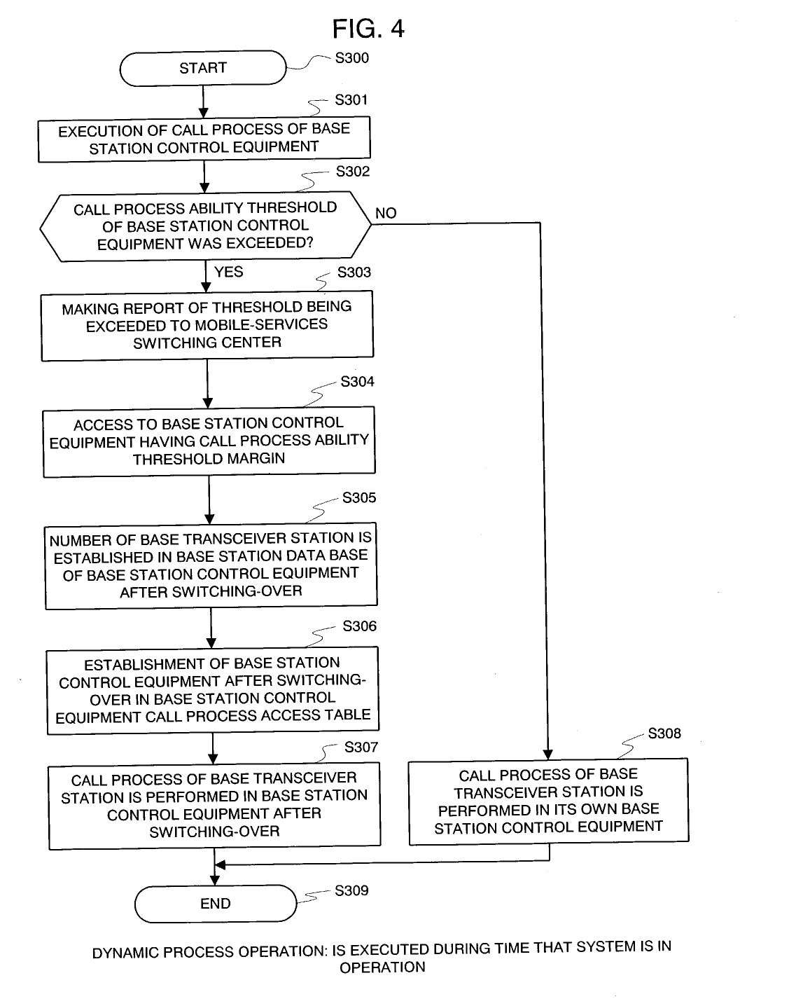

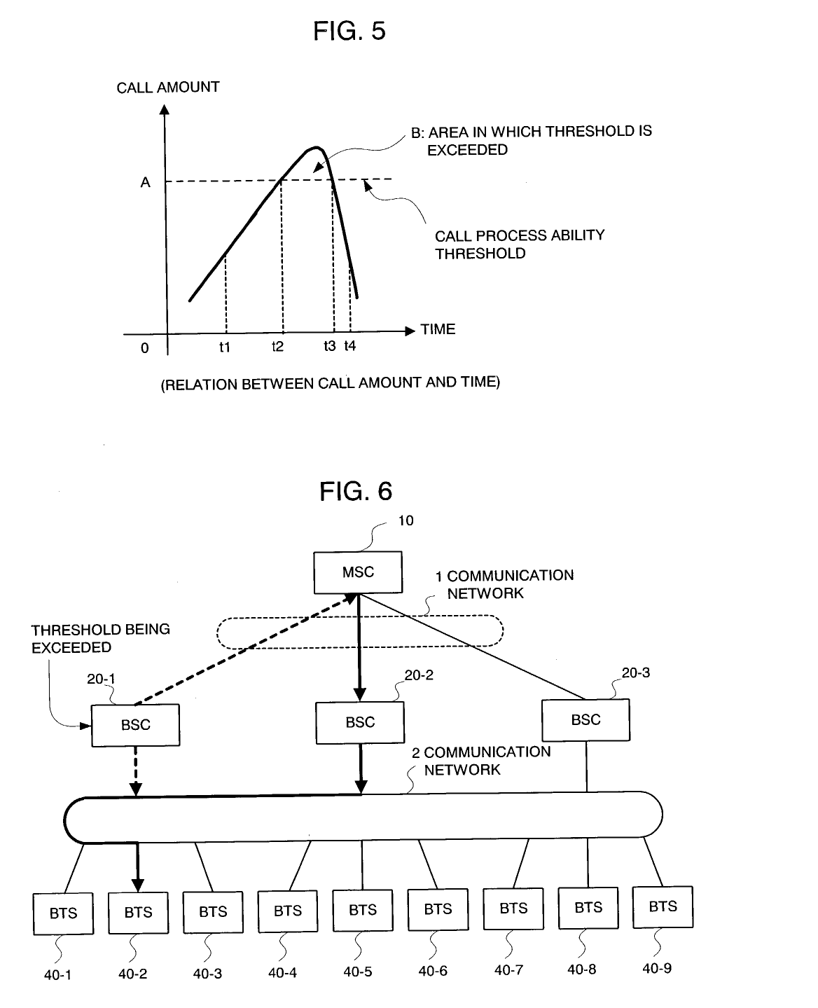

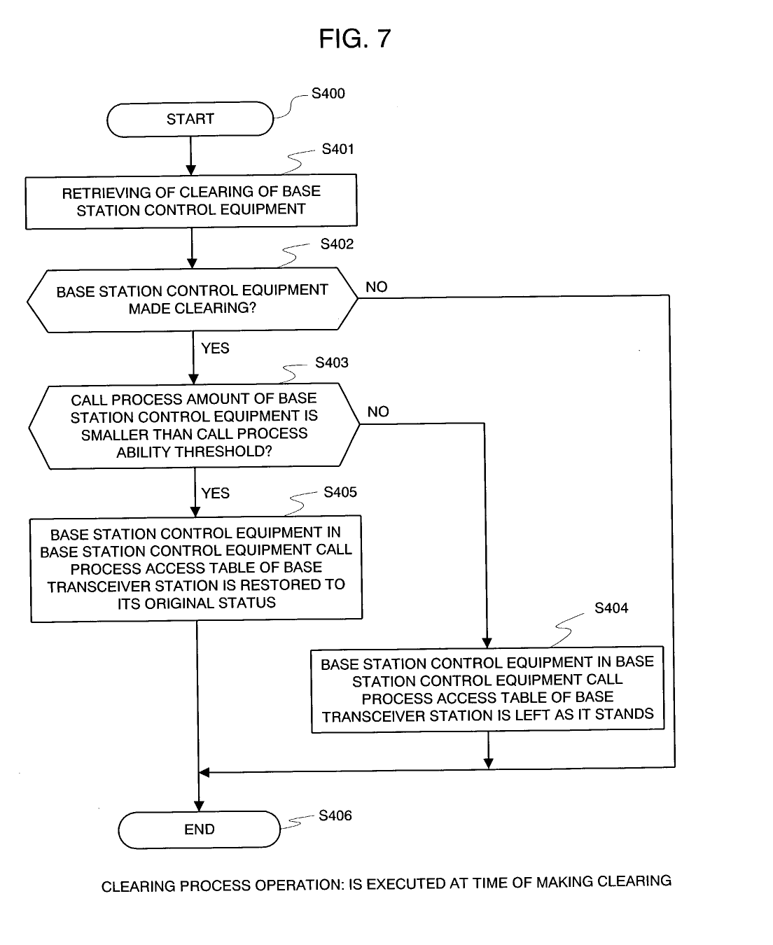

Next, an operation of this embodiment shown in FIG. 1 and FIG. 2 will be explained by referring to FIG. 3, FIG. 4, FIG. 5, FIG. 6, and FIG. 7.

The operation of this embodiment is executed in the initial stage of the start of the cellular mobile communication system shown in FIG. 1 and FIG. 2, and two operations exist of a pre-set process operation for judging the call process ability threshold of each kind of the BTS 40 in advance, and a dynamic process operation for judging at each call process whether the call process ability threshold pre-established in the BSC 20 was not exceeded.

At first, the pre-set process operation will be explained by referring to FIG. 3.

FIG. 3 is a flow chart explaining the pre-set process operation of this embodiment.

In the cellular mobile communication system shown in FIG. 1 and FIG. 2, as a basic establishment before the start of the system, it is presumed that the BSC 20-1 was established in advance so as to manage the BTSes 40-1, 40-2, and 40-3 as subordinates, the BSC 20-2 to manage the BTSes 40-4, 40-5, and 40-6 as subordinates, and also, the BSC 20-3 to manage the BTSes 40-7, 40-8, and 40-9 as subordinates. That is, as an example, in the event of the BSC 20-1, it is presumed that the base station numbers of the BTSes 40-1, 40-2, and 40-3 were established in the base station data base 21-1, and conversely, the BSC 20-1 was registered as the BSC 20 to be normally connected in the standard base station control equipment storage sections 44-1, 44-2, and 44-3 on the BTS 40 side, and yet the BSC 20-1 was registered in the base station control equipment call process access tables 45-1, 45-2, and 45-3 as well.

In FIG. 3, at first, when the BTS 40-1 transmits an ATM packet to the BSC 20 of an access destination, i.e. the BSC 20-1 registered in the base station control equipment call process access table 45-1 for making access, the pre-set process operation of the BSC 20-1 is started (step S200), and the base station data base 21-1 is retrieved by the base station data processing section 22-1 of the BSC 20-1 to confirm whether the BTS 40-1 of an access source is under command of its own BSC 20-1 (step S201). Since the base station number of the BTS 40-1 was established in the base station data base 21-1, it is confirmed that the above BTS 40-1 is under command of its own BSC 20-1, next, by the traffic data acquisition section 25-1, a traffic upper-limit value of the BTS 40-1 and a traffic measurement value that is a current traffic of the BTS 40-1 are acquired from the traffic upper-limit storage section 43-1 of the BTS 40-1 and the traffic measurement section 11 of the MSC 10 respectively (step S202), and by determining whether the traffic measurement value did not exceed the traffic upper-limit value, it is determined whether the call process ability of the BTS 40-1 was not exceeded (step S203).

In the event that the traffic measurement value did not exceed the traffic upper-limit value, it is determined that the current traffic measurement value did not exceed the call process ability threshold of the above BTS 40-1 (No in the step S203), the base station number of the above BTS 40-1 is re-established in the base station data base 21-1 (step S204) to finish the process (the operation proceeds to step S207).

In the event that the traffic measurement value exceeded the traffic upper-limit value, it is determined that the current traffic measurement value exceeded the call process ability threshold of the above BTS 40-1 (Yes in the step S203), the base station number of the above BTS 40-1 is deleted from the base station data base 21-1 (step S205), and the base station number of the above BTS 40-1 is sent to the base station control equipment processing section 14 of the MSC 10 from the base station data processing section 22-1, and is registered in the green base station table 13 (step S206) to finish the process (step S207).

Next, when the BTS 40-2 transmits an ATM packet to the BSC 20 of an access destination, i.e. the BSC 20-1 registered in the base station control equipment call process access table 45-2 for making access, the pre-set process operation of the BSC 20-1 is started (step S200), and the base station data base 21-1 is retrieved by the base station data processing section 22-1 of the BSC 20-1 to confirm whether the BTS 40-2 of an access source is under command of its own BSC 20-1 (step S201). Hereinafter, the pre-set process operation of the BSC 20-1 proceeds in a similar manner that the operation of the case that access was made by the BTS 40-1 does. Also, the BTS 40-3 also makes similarly access to the BSC 20-1 thereafter, and the pre-set process operation of the BSC 20-1 is carried out, and is finished.

Additionally, the BSC 20-2, and BTSes 40-4, 40-5, and 40-6 under command thereof also carry out the pre-set process operation in the BSC 20-2 similarly, the BSC 20-3, and BTSes 40-7, 40-8, and 40-9 under command thereof also carry out the pre-set process operation in the BSC 20-3 in a similar manner to finish the operation.

When the pre-set process operation of all kinds of the BSC 20 is finished, the MSC 10 retrieves whether the BTS 40 was registered in the green base station table 13. If the BTS 40 was registered, it means that the above BTS 40 is not under command of any kind of the BSC 20 yet, whereby the base station control equipment processing section 14 of the MSC 10 retrieves and assigns the BSC 20, of which the threshold of the call process ability was not exceeded, from the call process ability registration table 12, and registers the BTS 40 registered in the green base station table 13 of the MSC 10 to the base station data base 21 of the above BSC 20, and the BTS 40 registered in the base station data base 21 of the above BSC 20 is deleted from the green base station table 13. Thereby, in the pre-set process operation of the BSC 20, it becomes possible to cause the BTS 40, which did not belong to any kind of the BSC 20, to belong to the subordinate of the BSC 20 of which the call process ability was not exceeded. Additionally, the BSC 20, of which its own base station data base 21 had the BTS 40 registered newly by the MSC 10, establishes its own BSC 20 in the base station control equipment call process access table 45 of the above BTS 40 by the base station data processing section 22, and gives a notice that the above BTS 40 was positioned under command of its own BSC 20.

Next, the dynamic process operation will be explained by referring to FIG. 4, FIG. 5, FIG. 6 and FIG. 7.

FIG. 4 is a flow chart explaining the dynamic process operation of this embodiment.

The dynamic process operation is an operation to be executed at every call of the MS 60 in the event that the pre-set process operation of the cellular mobile communication system shown in FIG. 1 and FIG. 2 was finished and the system was placed in operation. In the dynamic process operation, it is determined at each call whether the call process ability threshold pre-established in the BSC 20 was not exceeded, in the event that the call process ability threshold of the BSC 20 was not exceeded, the process of the above call is performed in the above BSC 20, and in the event that the call process ability threshold of the BSC 20 was exceeded, the BSC 20 is switched over to cause the other BSC 20 having a margin of the call process ability to perform the process of the above call for executing a load distribution of the BSC 20.

Additionally, for simplification of subsequent explanation, it is presumed that the BSC 20-1 was established so as to manage the BTSes 40-1, 40-2, and 40-3 as subordinates, the BSC 20-2 to manage the BTSes 40-4, 40-5, and 40-6 as subordinates, and also, the BSC 20-3 to manage the BTSes 40-7, 40-8, and 40-9 as subordinates.

Now, when it is presumed that a call occurred in the MS 60-2 of FIG. 2, the above call reaches the call process correspondence section 23-1 of the BSC 20-1 via the radio control section 41-2 and the communication circuit control section 42-2 of the BTS 40-2, and the dynamic process operation of the BSC 20-1 is started (step S300 of FIG. 4). The BSC 20-1 initiates execution of the process of the above call (step S301). Next, the BSC 20-1 determines, when its own BSC 20-1 performs the process of the above call (the connection process of the call etc.), whether or not the call process ability threshold pre-established in its own BSC 20-1 is exceeded (step S302).

In FIG. 5, one example of a relation between a call amount and time is illustrated.

FIG. 5 is a view schematically illustrating a status that the call amount of a longitudinal axis increase with time of a lateral axis, and also, decreases with time, and the above call amount indicates the amount of the call that reaches one kind of the BSC 20 (or one BTS 40). And, a call process ability threshold A is established in each kind of the BSC 20 respectively as the upper-limit value of the call amount that can be processed in the corresponding time, and in an example of FIG. 5, the call amount is below than the call process ability threshold A at time t1 or time t4, whereby the above call amount can be all processed; however the call amount is above than the call process ability threshold A between time t2 to time t3, whereby the call in the area indicated as an area B in which the threshold is exceeded becomes impossible to process in the above BSC 20.

And, as to each kind of the BSC 20, the value of its own call process ability threshold is established in the call process ability threshold comparison section 24 on each kind of the BSC 20 respectively.

Now, returning to FIG. 4, in the step S302, in the event that it was determined in the call process ability threshold comparison section 24-1 that, even though its own BSC 20-1 performed the process of the above call, the call process ability threshold of its own BSC 20-1 would not be exceeded (No in the step S302), the process of the above call is performed in its own BSC 20-1 (step S308) to finish the process (the operation proceeds to step S309).

In the step S302, in the event that it was determined in the call process ability threshold comparison section 24-1 that, if its own BSC 20-1 performed the process of the above call, the call process ability threshold of its own BSC 20-1 would be exceeded (Yes in the step S302), the BSC 20-1 makes a report of the threshold being exceeded to the base station control equipment processing section 14 of the MSC 10 from the base station data processing section 22-1 (step S303). The base station control equipment processing section 14 of the MSC 10, which received a report of the threshold being exceeded, retrieves the call process ability registration table 12, and selects and decides the other BSC 20 of which the call process ability threshold was not exceeded, i.e. the BSC 20 having a margin of the call process ability. Herein, for example, it is presumed that the BSC 20-2 was selected.

The base station control equipment processing section 14 makes access to the base station data processing section 22-2 of the newly-selected BSC 20-2 (step S304), and registers and establishes the base station number of the BTS 40-2 that is going to process the above call into the base station data base 21-2 of the BSC 20-2 (step S305).

The newly selected BSC 20-2 makes access to the BTS 40-2 from the base station data processing section 22-2, and establishes its own BSC 20-2 in the base station control equipment call process access table 45-2 of the BTS 40-2 (step S306).

The BTS 40-2, of which the base station control equipment call process access table 45-2 had the BSC 20-2 established, asks the established BSC 20-2 for a connection process of the above call, and the BSC 20-2 performs the process of the above call (step S307) to finish the process (step S309).

The operation mentioned above will be explained once again by referring to FIG. 6. Additionally, in FIG. 6, identical reference numerals or codes are affixed to components that correspond to ones shown in FIG. 1, and explanation thereof is omitted. A call that occurred was received in the BTS 40-2 of FIG. 6 to ask the BSC 20-1, which had the BTS 40-2 as a subordinate, for the process of the above call; however the call process ability threshold was exceeded in the BSC 20-1, whereby the BSC 20-1 made a report of the threshold being exceeded to the MSC 10, the MSC 10 switched the BSC 20-1 over to the BSC 20-2, and the process of the above call, which the BTS 40-2 received, was performed in the BSC 20-2 after switching-over (illustrated by wide lines of FIG. 6). In such a manner, in this embodiment, in the event that the load of a certain kind of the BSC 20 increased and the call process became impossible to perform, the other BSC 20 having a margin of the call process ability can be assigned for performing the call process, whereby it becomes possible to distribute the load of the BSC 20.

Above, the explanation was made by taking the operation at the time of performing the process of the call that occurred in the BTS 40-2 as one example; however the dynamic process operation of each call during the time that the system is in operation is similarly performed in the other BTS 40 as well.

Next, a clearing process operation will be explained by referring to FIG. 7

FIG. 7 is a flow chart explaining the clearing process operation of this embodiment. The clearing process operation is an operation to be executed in the event that the call process was performed in the other BSC 20 than the BSC 20 established as a basic establishment as to which kind of BSC 20 managed each BTS 40 as a subordinate before the start of the cellular mobile communication system shown in FIG. 1 and FIG. 2, and it is a process that is started at the time of making clearing of the above call. Now, quoting the example explained in the dynamic process operation of FIG. 4 once again, as a basic establishment, the BTS 40-2 was established so as to be managed as a subordinate of the BSC 20-1; however at the time of the process of a call explained in FIG. 4, the call process ability of the BSC 20-1 was exceeded, whereby the switching-over to the BSC 20-2 was made to perform the process of the above call. Accordingly, the clearing process operation is started in the BSC 20-2.

In FIG. 7, when a clearing notice reaches the BSC 20-2 from the BTS 40-2 (step S400), a clearing retrieval process in the BSC 20-2 is started (step S401), and it is determined whether the BSC 20-2 also made clearing (step S402).

If the BSC 20-2 did not make clearing (No in the step S402), the process is finished (the operation proceeds to step S406).

If the BSC 20-2 made clearing (Yes in the step S402), it is determined whether the call process amount of the BSC 20-2 became smaller than the call process ability threshold of the BSC 20-2 (step S403).

In the step S403, if the call process amount of the BSC 20-2 did not become smaller than the call process ability threshold (No in the step S403), the BSC 20-2 established in the base station control equipment call process access table 45-2 of the BTS 40-2 is left as it stands (step S404) to finish the process (step S406). In the step S403, if the call process amount of the BSC 20-2 became smaller than the call process ability threshold (Yes in the step S403), the BSC 20-2 established in the base station control equipment call process access table 45-2 of the BTS 40-2 is restored to its original status (step S405), i.e. to the BSC 20-1 to finish the process (step S406).

By performing the operation mentioned above, in the event that the load of the BSC 20, which had been heavy, became light, the BTS 40 under command thereof can be restored so that it is managed as a subordinate of its original BSC 20.

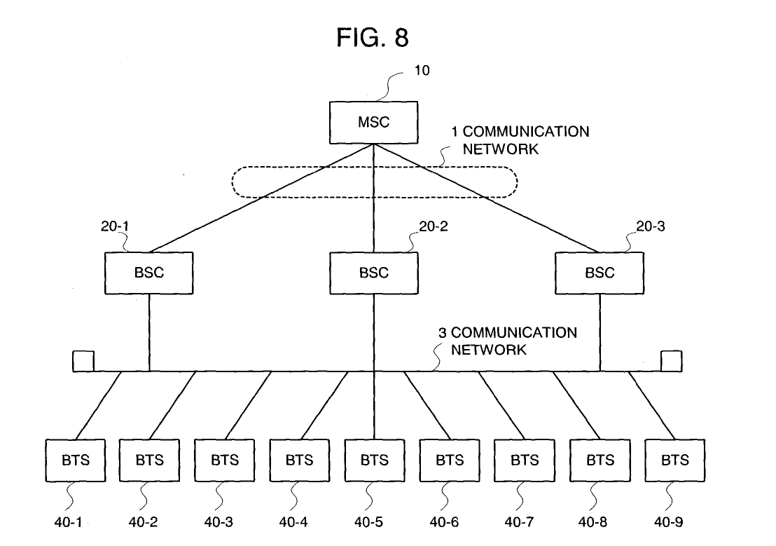

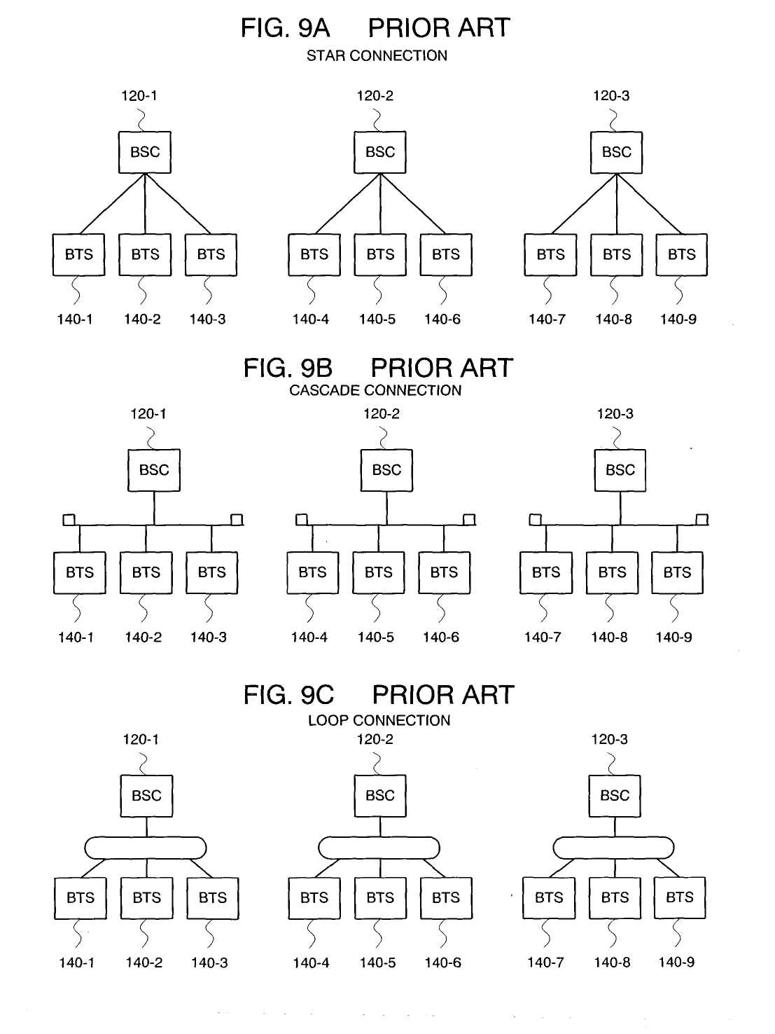

Next, a second embodiment of the base station control equipment load distributed system of the present invention will be explained by referring to FIG. 8.

FIG. 8 is a block diagram illustrating the second embodiment of the base station control equipment load distributed system of the present invention.

The second embodiment shown in FIG. 8 is configured of an MSC (Mobile-services Switching Center) 10, a plurality of kinds of BSC (Base Station Control equipment) 20 (20-1, 20-2 and 20-3), and a plurality of BTSes (Base Transceiver Station) 40 (40-1 to 40-9), the MSC 10 and each kind of BSC 20 are connected via a communication network 1, and further each kind of the BSC 20 is connected to a plurality of the BTSes 40 in a cascade shape via a communication network 3. That is, the second embodiment shown in FIG. 8 differs only in a point that each kind of the BSC 20 and each BTS 40 are connected in a cascade shape as compared with the first embodiment shown in FIG. 1, and the others than this point are all the same as that of FIG. 1. And, the detailed configuration of the MSC 10, the BSC 20 and the BTS 40 that are components is also identical to that shown in FIG. 2.

Accordingly, in the second embodiment, the identical operation to that of the first embodiment can be carried out, and the identical operational advantage/effect to that of the first embodiment can be obtained, whereby further explanation of the second embodiment is omitted.

As explained above, the base station control equipment load distributed system of the present invention comprises a function capable of retrieving the base station control equipment (BSC) on which the call processes concentrate, and yet can select, in the event that the load of the call process concentrated on a specific kind of the base station control equipment, the other base station control equipment of which the load is light to causes the above base station control equipment to bear the part of the above call process, whereby it has the effect that it becomes possible to execute the load distribution of the base station control equipment, and the effect that the resource of the cellular mobile communication system can be effectively used.

Also, if, by any chance, the base station control equipment should fail, the call process can be covered in the other base station control equipment, whereby it has the effect that it becomes possible to execute the stable operation of the cellular mobile communication system, and the effect that reliability of the system improves.

What is claimed is:

1. In a cellular mobile communication system comprising; an MSC (Mobile-services Switching Center); a plurality of kinds of BSC (Base Station Control equipment) to be connected to said MSC via a first communication network; and a plurality of BTSes (Base Transceiver Station) to be connected to said plurality of kinds of said BSC via a second communication network, said second communication network being a loop network, a base station control equipment load distributed system, characterized in that:
said MSC comprises load status supervision/control means for supervising and controlling a load status of said plurality of kinds of said BSC;
each of said plurality of kinds of said BSC comprises data management means for managing a base station number etc. of the BTS to be managed as a subordinate of its own BSC, and call process ability management means for managing call process ability of its own BSC and the BTS under command thereof, respectively;
each of said plurality of said BTSes comprises base station control equipment storage means for storing the BSC to which its own BTS should make access, respectively; and
in the event that load of a call process of any kind of the BSC became heavy and the process of a call became impossible to perform in the above BSC, said load status supervision/control means of said MSC switches over so as to select the other kind of the BSC of which load is light for causing it to perform the process of the above call.

2. The base station control equipment load distributed system of claim 1, wherein said load status supervision/control means of said MSC comprises:
a traffic measurement section for measuring a traffic amount of each kind of said BSC and each of said BTSes;
a call process ability registration table for establishing the BSC of which a call process ability threshold was not exceeded;
a green base station table for, in the event that the call process ability of any kind of the BSC was exceeded and the call process became impossible to start, registering the BTS under command of the above BSC; and
a base station control equipment processing section for performing a supervision/control process of each kind of said BSC by referring to said call process ability registration table and said green base station table.

3. The base station control equipment load distributed system of claim 2, wherein:
said data management means of said BSC comprises a base station data base for establishing the base station number of the BTS that its own BSC manages, and a base station data processing section for carrying out registration/deletion of the base station number to/from said base station data base, and registration of its own BSC for said base station control equipment storage means of the BTS that its own BSC manages; and
said call process ability management means comprises a call process correspondence section for performing the call process for said BTS, a call process ability threshold comparison section for making a comparison of the current call process ability of its own BSC and the BTS under command thereof with a pre-established call process ability threshold, and a traffic data acquisition section for acquiring and housing traffic data that said MSC measured in said traffic measurement section.

4. The base station control equipment load distributed system of claim 3, wherein:
said base station control equipment storage means of said BTS comprises a standard base station control equipment storage section in which the BSC, to which its own BTS is normally connected, was registered, and a base station control equipment call process access table in which the BSC, which its own BTS asks for the process of a current call, is registered; and
said BTS further comprises a traffic upper-limit storage section in which an upper-limit value of the call process ability of its own BTS is established.

5. The base station control equipment load distributed system of claim 4, characterized in that:
in an initial stage of a system start, when said BTS transmits an ATM packet to the BSC of an access destination registered in said base station control equipment call process access table for making access, a pre-set process operation of said BSC is started;
said base station data base is retrieved by said base station data processing section of said BSC to confirm whether said BTS of an access source is under command of its own BSC;
by said traffic data acquisition section, a traffic upper-limit value of said BTS and a traffic measurement value are acquired from said traffic upper-limit storage section of said BTS and said traffic measurement section of said MSC respectively, said traffic measurement value being a current traffic of said BTS;
by determining whether said traffic measurement value did not exceed said traffic upper-limit value, it is determined whether the call process ability of said BTS was not exceeded;
in the event that said traffic measurement value did not exceed said traffic upper-limit value, it is determined that said current traffic measurement value did not exceed a call process ability threshold of the above BTS, and the base station number of the above BTS is re-established in said base station data base to finish the process;
in the event that said traffic measurement value exceeded said traffic upper-limit value, it is determined that said current traffic measurement value exceeded the call process ability threshold of the above BTS, and the base station number of the above BTS is deleted from said base station data base; and
the base station number of the above BTS is sent to said base station control equipment processing section of said MSC from said base station data processing section, and is registered in said green base station table to finish the process.

6. The base station control equipment load distributed system of claim 5, characterized in that:
when the pre-set process operation is finished in all kinds of said BSC, said MSC retrieves whether the BTS was registered in said green base station table;
if the BTS was registered, said base station control equipment processing section of said MSC retrieves and assigns the BSC, of which the threshold of the call process ability was not exceeded, from said call process ability registration table, and registers the BTS registered in said green base station table to said base station data base of the above BSC, and said BTS registered in said base station data base of the above BSC is deleted from said green base station table; and
the BSC, of which said base station data base of its own had said BTS registered newly by said MSC, establishes its own BSC in said base station control equipment call process access table of the above BTS by said base station data processing section.

7. The base station control equipment load distributed system of claim 6, characterized in that:
when the operation described finished, and the cellular mobile communication system is placed in operation, a dynamic process operation is started at each call of the MS (Mobile Station);
in said dynamic process operation, it is determined at each call whether the call process ability threshold pre-established in said BSC was not exceeded;
in the event that the call process ability threshold of said BSC was not exceeded, the process of the above call is performed in the above BSC; and
in the event that the call process ability threshold of said BSC was exceeded, the BSC is switched over so as to cause the other BSC having a call process ability margin to perform the process of the above call for executing a load distribution of the BSC.

8. The base station control equipment load distributed system of claim 6, characterized in that:
when the operation described is finished, and the cellular mobile communication system is placed in operation, at the time that a call occurred in the MS (Mobile Station), the above call reaches said call process correspondence section of the BSC via said radio control section and said communication circuit control section of the BTS, and the dynamic process operation of said BSC is started;
said BSC initiates execution of the process of the above call;
said BSC determines, if its own BSC performs the process of the above call, whether or not the call process ability threshold pre-established in its own BSC is exceeded;
in the event that it was determined in said call process ability threshold comparison section that, even though its own BSC performed the process of the above call, the call process ability threshold of its own BSC would not be exceeded, the process of the above call is performed by its own BSC to finish the process;
in the event that it was determined in said call process ability threshold comparison section that, if its own BSC performed the process of the above call, the call process ability threshold of its own BSC would be exceeded, said BSC makes a report of the threshold being exceeded to said base station control equipment processing section of said MSC from said base station data processing section;
said base station control equipment processing section of said MSC, which received a report of the threshold being exceeded, retrieves said call process ability registration table, and selects and decides the other BSC of which the call process ability threshold was not exceeded, and said base station control equipment processing section makes access to said base station data processing section of said other BSC that was newly-selected, and registers and establishes the base station number of said BTS that is going to process the above call into said base station data base of said other BSC;
said other BSC, which was newly selected, makes access to said BTS from said base station data processing section, and establishes its own BSC (said other BSC) in said base station control equipment call process access table of said BTS; and
said BTS, of which said base station control equipment call process access table had said other BSC established, asks said other BSC, which was established, for a connection process of the above call, and said other BSC performs the process of the above call to finish the process.

9. The base station control equipment load distributed system of claim 8, characterized in that:
when the operation described is finished, and a clearing notice reaches said BSC from said BTS, a clearing retrieval process in said BSC is started;
it is determined whether said BSC also made clearing, if said BSC did not make clearing, the process is finished, and if said BSC made clearing, it is determined whether a call process amount of said BSC became smaller than the call process ability threshold of said BSC;
if a call process amount of said BSC did not become smaller than the call process ability threshold, the BSC established in said base station control equipment call process access table of said BTS is left as it stands to finish the process; and
if a call process amount of said BSC became smaller than the call process ability threshold, the BSC established in said base station control equipment call process access table of said BTS is restored to its original status to finish the process.

10. In a cellular mobile communication system comprising an MSC (Mobile-services Switching Center), a plurality of kinds of BSC (Base Station Control equipment) to be connected to said MSC via a first communication network, and a plurality of BTSes (Base Transceiver Station) to be connected to said plurality of kinds of said BSC in a cascade shape via a third communication network, a base station control equipment load distributed system, comprising:
said MSC comprises load status supervision/control means for supervising and controlling a load status of said plurality of kinds of said BSC;
each of said plurality of kinds of said BSC comprises data management means for managing a base station number etc. of the BTS to be managed as a subordinate of its own BSC, and call process ability management means for managing call process ability of its own BSC and the BTS under command thereof, respectively;
each of said plurality of said BTSes comprises base station control equipment storage means for storing the BSC to which its own BTS should make access; and
in the event that load of a call process of any kind of the BSC became heavy and the process of a call became impossible to perform in the above BSC, said load status supervision/control means of said MSC switches over so as to select the other kind of the BSC, of which load is light, for causing it to perform the process of the above call.
